(19) United States
(12) Patent Application Publication
(10) Pub. No.: US 2016/0089927 A1
(43) Pub. Date: Mar. 31, 2016

(54) MULTI-FUNCTIONAL PORTABLE PEN STRUCTURE

(71) Applicants: CHIN-HAI HSU, Yilan City (TW); LI-HUA You, Yilan City (TW)

(72) Inventors: CHIN-HAI HSU, Yilan City (TW); LI-HUA You, Yilan City (TW)

(21) Appl. No.: 14/502,154

(22) Filed: Sep. 30, 2014

(51) Int. Cl. B43K 29/00; B43K 29/10; A47G 21/06; G01K 13/00; F21V 33/00; B43K 29/08; B43K 23/12

(52) U.S. Cl. CPC B43K 29/004; B43K 29/08; B43K 29/10; B43K 23/126; G01K 13/00; F21V 33/0084; A47G 21/103; F21Y 2101/02

(57) ABSTRACT

A multi-functional portable pen structure comprises a pen barrel and a pen cap to be capped onto the pen barrel, wherein the pen barrel is for storing retractable chopsticks disposed with pen refills and sheaths. In the pen cap is installed a control circuit whereon are disposed a laser element, LED, temperature detector, liquid crystal display, and a plurality of manipulating keys. The laser element, LED, liquid crystal display, and manipulating keys separately protrude from the pen cap, and the temperature detector is disposed on the clamping bar of the pen cap. The portable pen is easy to carry around and provides the functions of laser pointing, illumination, temperature measurement, eco-chopsticks, and writing instrument.

### BACKGROUND OF THE INVENTION

1. Field of the Invention

The present invention relates to a multi-functional portable pen structure, particularly to a multi-functional portable pen structure which is easy to carry and which provides the functions of a laser pointer, illuminator, temperature measuring instrument, eco-chopsticks, and writing tool.

2. Description of Related Art

With the advancement of technology, our lives are surrounded by compact electronic products such as laser pens simply for pointing, compact illuminating lamps for lighting, thermometers for measuring body temperature, etc. Further, rising awareness of environmental protection and personal hygiene has made it a common consensus to carry eco-chopsticks around for daily use. However, carrying all the foregoing products in one bag or pouch presents some problems. These products would scatter about, would be hard to locate when in need, and are easily lost. With several years of experiences in related business and after constant research and experiments, the applicant has invented a multi-functional portable pen to combine in one portable product the functions of a laser pointer, illuminator, temperature measuring instrument, eco-chopsticks, and writing tool.

### SUMMARY OF THE INVENTION

The primary object of the present disclosure is to provide a multi-functional portable pen structure which provides the functions of a laser pointer, illuminator, temperature measuring instrument, eco-chopsticks, and writing tool and which can be easily carried around for use anytime and anywhere.

The foregoing multi-functional portable pen structure comprises a pen barrel and a pen cap to be capped onto the pen barrel, wherein the pen barrel is for storing retractable chopsticks disposed with pen refills and sheaths. In the pen cap is installed a control circuit, whereon are disposed a laser element, an LED, a temperature detector, a liquid crystal display, and a plurality of manipulating keys. The laser element, LED, liquid crystal display, and manipulating keys protrude separately outside the pen cap. The temperature detector is disposed on the clamping bar of the pen cap. The portable pen as described above is easy to carry around and provides the functions of a laser pointer, illuminator, temperature measuring instrument, eco-chopsticks, and writing tool.

### BRIEF DESCRIPTION OF THE DRAWINGS

FIG. 1 is a three-dimensional view of the present invention.

FIG. 2 is a breakdown three-dimensional view of the present invention.

FIG. 3 is a first drawing of the present invention in use.

FIG. 4 is a second drawing of the present invention in use.

FIG. 5 is a third drawing of the present invention in use.

FIG. 6 is a fourth drawing of the present invention in use.

### DETAILED DESCRIPTION OF THE PREFERRED EMBODIMENTS

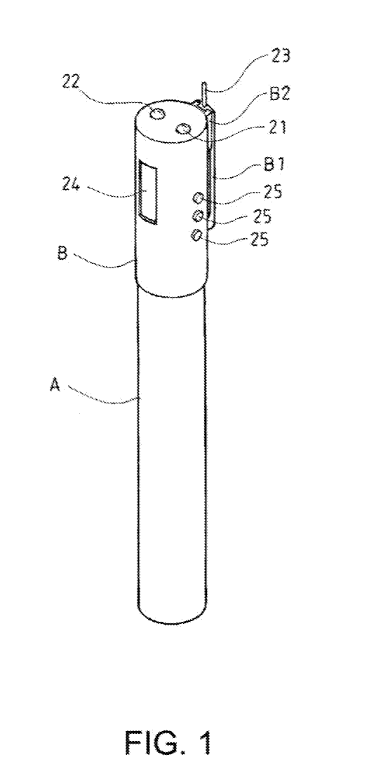

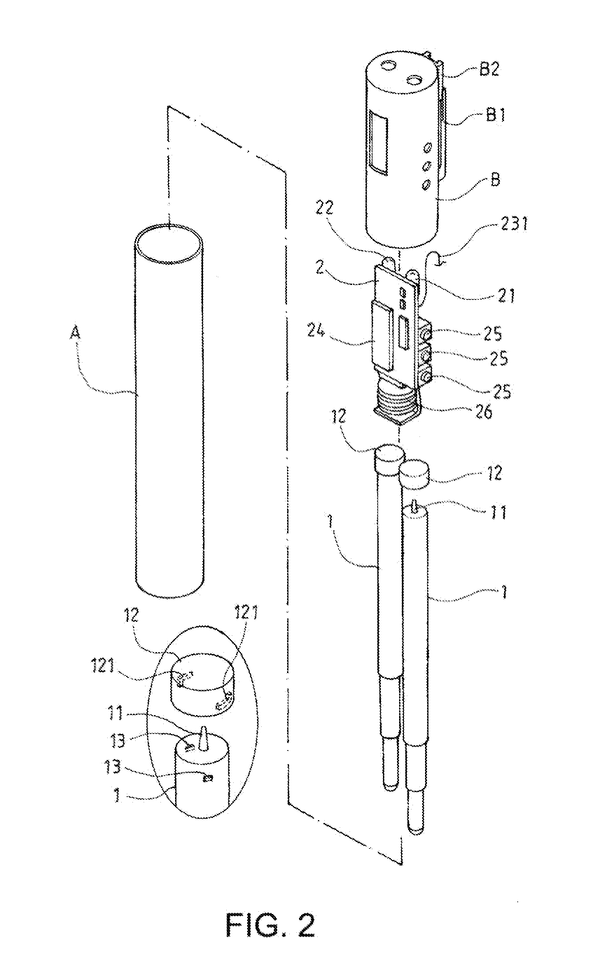

Please refer to both FIGS. 1 and 2. which are respectively a three-dimensional view and a breakdown three-dimensional view of the present invention. As shown in these figures, the present invention comprises a pen barrel A and a pen cap B to be capped onto the pen barrel A, wherein the pen barrel A is for storing retractable chopsticks 1. In the chopsticks 1 are disposed pen refills, the pen tips 11 thereof protrude from the tops of the chopsticks 1. A sheath 12 is capped onto the top of each of the chopsticks 1 to cover and protect the pen tips 11 of the pen refills. On the sheaths 12 and on the periphery of the tops of the chopsticks 1 are respectively disposed tenons 121 and 13. The sheaths 12 are capped onto the tops of the chopsticks and turned, with the tenons 121 and 13 wedged together and securing the sheaths. On one side of the pen cap B is disposed a clamping bar B1, inside of which is installed a control circuit 2. On the control circuit 2 are disposed a laser element 21, an LED 22, a temperature detector 23, a liquid crystal display 24, and a plurality of manipulating keys 25. The laser element 21, LED 22, liquid crystal display 24, and manipulating keys 25 protrude separately outside the pen cap B in appropriate locations. The temperature detector 23 is connected to the control circuit 2 via a wiring 231, and is disposed on an end of the clamping bar B1. The temperature detector 23 can be made of any metal object that is susceptible to temperature. The clamping bar B1 is embedded in a protrusion B2 disposed on the pen cap B. The clamping bar B1 may slide upwards along the protrusion B2 and cause the temperature detector 23 to protrude from the top of the pen cap B or may slide downwards to be hidden on one side of the pen cap B. The work power supply of the entire control circuit 2 is provided by a plurality of batteries 26. The foregoing components are combined to form a multi-functional portable pen. With its clamping bar B1, the portable pen can be clamped to a pocket or other objects and be easily carried around to serve the functions of a laser pointer, illuminator, temperature measurement instrument, eco-chopsticks, and writing tool. The combination of various functions in one single structure enhances its facility.

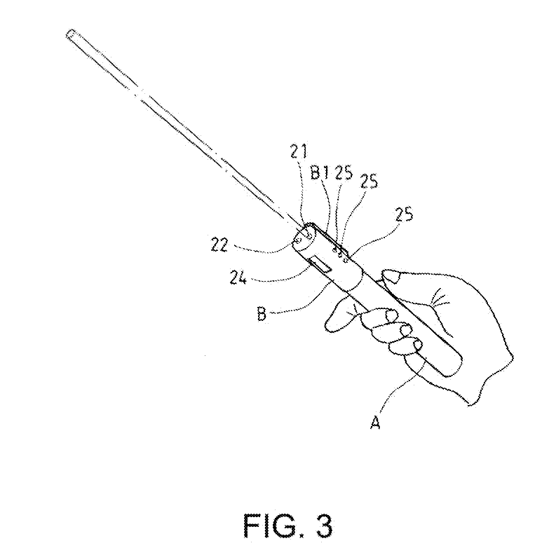

Please refer now to FIG. 3, which shows a first drawing of the present invention in use. Refer also to FIG. 2. As the figures present, when the present invention is in use, a press of one of the manipulating keys 25 turns on the laser element 21 through the control circuit 2. The laser element 21 projects concentrated light spots outwardly to form a dotted highlight pointer for use in presentations, lectures, or teaching.

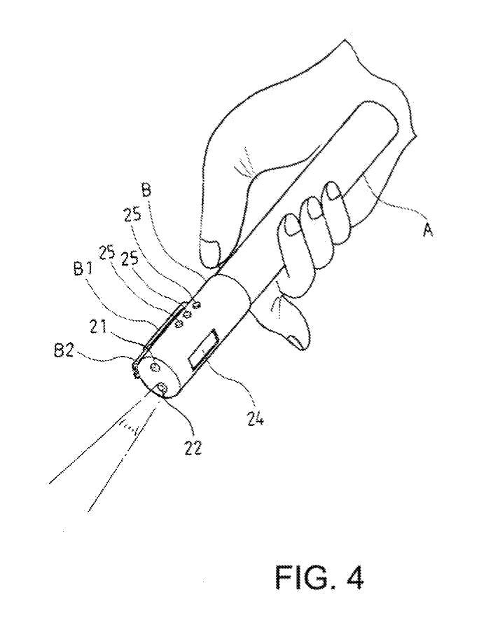

Please refer to FIG. 4, which shows a second drawing of the present invention in use. Please also refer to FIG. 2. As these figures show, when the present invention is in use, a press of one of the manipulating keys 25 turns on the LED 22 through the control circuit 2 and lights the LED 22. The LED 22 is of high-brightness. In dark or dusky environments, the light source provided by the LED 22 can illuminate like a flashlight.

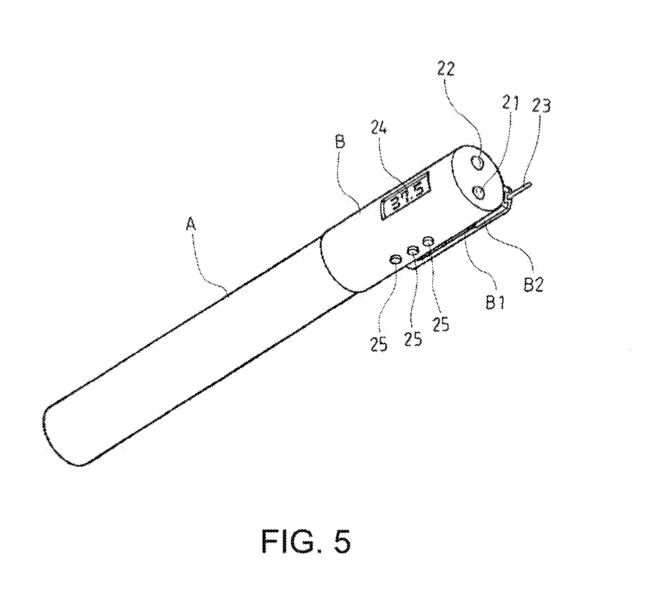

Please refer to FIG. 5, which shows a third drawing of the present invention in use. Please also refer to FIG. 2. As these figures show, when the present invention is in use, the clamping bar B1 may slide upwards along the protrusion B2 and cause the temperature detector 23 to protrude from the top of the pen cap B. Then the portable pen can be placed under one's armpit or on one's forehead so that the temperature detector 23 contacts the armpit or the forehead to sense the body temperature. The temperature detector 23 can be made of any metal object that is susceptible to temperature to facilitate temperature measuring. After the control circuit 2 reads the result, the body temperature datum is displayed on the liquid crystal display 24. With the multi-functional portable pen, one's body temperature can be measured anytime and anywhere without use of an additional thermometer.

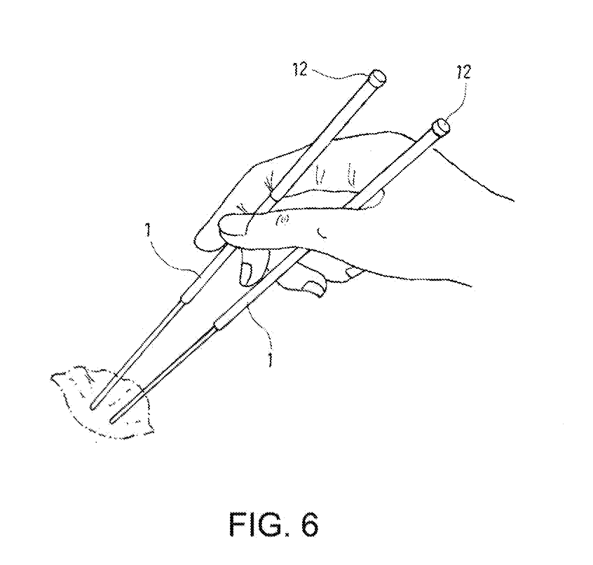

Please refer to FIG. 6, which shows a fourth drawing of the present invention in use. Please also refer to FIG. 2. As these figures show, when the present invention is in use, the pen cap B can be opened and chopsticks 1 can be taken out from the pen barrel A. The tips of the pen refills 11 can be exposed by opening the sheaths 12 and held in the chopsticks 1 for use in writing without need of carrying an additional writing instrument. The chopsticks 1 can also be extended to its full length to form a pair of eco-chopsticks when one dines away from home without need of disposable chopsticks. In this way, the purpose of personal hygiene and environmental protection is achieved.

The foregoing descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

According to the above, the present invention is a multi-functional portable pen structure comprising a pen barrel and a pen cap to be capped onto the pen barrel with retractable chopsticks disposed inside the pen barrel and a control circuit disposed on the pen cap. The portable pen can be used for laser pointing, illumination, temperature measurement, and can be used as eco-chopsticks and a writing instrument. It can be easily carried around for use anytime and anywhere. It can therefore be said that the present invention is a practical and novel invention.

What is claimed is:

1. A multi-functional portable pen structure, comprising:
a pen barrel for storing retractable chopsticks wherein are disposed pen refills whose tips protrude from the tops of the chopsticks;
a pen cap to be capped onto the pen barrel, wherein is installed a control circuit in which are disposed a laser element, an LED, a temperature detector, a liquid crystal display, and a plurality of manipulating keys to provide the functions of laser pointing, illumination, temperature measurement, eco-chopsticks, and writing instrument anytime and anywhere;
wherein the laser element, LED, liquid crystal display, and manipulating keys separately protrude from the pen cap in appropriate locations; and wherein the temperature detector is connected to a wiring and is disposed on the clamping bar of the pen cap.

2. The multi-functional portable pen structure as defined in claim 1, wherein sheaths are capped onto the tops of the chopsticks to cover and protect the tips of the pen refills.

3. The multi-functional portable pen structure as defined in claim 1, wherein the temperature detector is disposed on an end of the clamping bar, wherein the clamping bar is embedded in a protrusion disposed on the pen cap, and wherein the clamping bar may slide upwards along the protrusion and cause the temperature detector to protrude from the top of the pen cap or may slide downwards to be hidden on one side of the pen cap.

4. The multi-functional portable pen structure as defined in claim 1, wherein the temperature detector can be made of any metal object that is susceptible to temperature.
